(19) United States
(12) Patent Application Publication
(10) Pub. No.: US 2023/0196300 A1
(43) Pub. Date: Jun. 22, 2023

(54) ATTENDANCE RECORDING TERMINAL WITH USER-SPECIFIC INTERACTION

(71) Applicant: dormakaba EAD GmbH, Villingen-Schwenningen (DE)

(72) Inventors: Andreas REINBOLD, Villingen-Schwenningen (DE); Martin RUOF, Villingen-Schwenningen (DE)

(21) Appl. No.: 18/085,330

(22) Filed: Dec. 20, 2022

(30) Foreign Application Priority Data
Dec. 22, 2021 (EP) EP21216900.7

(51) Int. Cl. G06Q 10/1091

(52) U.S. Cl. CPC G06Q 10/1091

(57) ABSTRACT

An attendance recording terminal, in particular time recording terminal, for recording attendance information of a person on the basis of an action of the person includes a control unit, a memory management unit having a master record of personal data, and an identification engine is configured for identifying the person and for outputting identification information. The control unit is configured for interacting with the memory management unit in such manner that it checks in the master record, depending on the identification information, as to what type of interaction the identified person wants with the attendance recording terminal. Furthermore, the control unit is configured in such manner that a user-specific type of interaction is provided for the identified person on the attendance recording terminal and/or on a mobile access medium of the person. A corresponding computer-implemented method for operating an attendance recording terminal is also related.

### CROSS-REFERENCE TO RELATED APPLICATIONS

This application is related to and claims the benefit of European Patent Application No. 21216900.7, filed on Dec. 22, 2021, the contents of which are herein incorporated by reference in their entirety.

### TECHNICAL FIELD

The present disclosure relates to an attendance recording terminal for recording attendance information of a person on the basis of an action of the person. In particular, the disclosure relates to a time recording terminal. Furthermore, the present disclosure relates to a computer-implemented method for operating a corresponding attendance recording terminal, in particular time recording terminal, for recording attendance information of a person on the basis of an action of the person, and a corresponding computer program.

### BACKGROUND

Attendance recording terminals are particularly widespread in the world of work for recording the attendance of an employee. Attendance recording terminals are often found in office buildings, factory buildings or even hospitals. A system is provided by means of the attendance recording terminals, which allows electronic recording and storage of employee attendances. In the case of a time recording terminal, the terminal is also used to record and store the working hours completed. In general, in this context, the attendance information of a person is mentioned, which person would like to clock in for work via the attendance recording terminal or, for example, log out for a break or at the end of the working day or clock out of the system.

Attendance recording terminals allow a point to be provided for people to interact centrally, for example at a point in the entrance area of an office building or on every floor or in every department of a building/company, via which the clocking processes can be easily implemented. A central system is then available to the employer, for example via the memory management unit of the attendance recording terminal, via which the employer can track the attendance information of the individuals without significant effort.

Conventional attendance recording terminals, on which the present disclosure is based, only provide a single type of interaction with the users. In doing so, user-specific needs or preferences or even necessary requirements of an individual user are generally not taken into account.

### SUMMARY

Against this background, the present disclosure provides an improved attendance recording terminal in which the interaction with the attendance recording terminal is designed to be more user-friendly and easier to operate for all users.

Furthermore, the present disclosure also provides a corresponding computer-implemented method for operating an attendance recording terminal or a corresponding computer program in order to further increase the user-friendliness and simplicity of the interaction for all users.

According to the disclosure, the mentioned advantages are achieved by providing the proposed attendance recording terminal, in particular time recording terminal, for recording attendance information of a person on the basis of an action of the person, and by the proposed computer-implemented method for operating an attendance recording terminal, and by the proposed computer program having the features of the corresponding independent claims. In addition, preferred embodiments can be found in the dependent claims and the description.

Specifically, an attendance recording terminal for recording attendance information of a person on the basis of an action of the person is proposed. The proposed attendance recording terminal can in particular be a time recording terminal. The proposed attendance recording terminal includes:
a control unit,
a memory management unit, wherein the memory management unit comprises a master record of personal data, and
an identification engine, wherein the identification engine is configured for identifying the person and for outputting identification information.

The control unit is configured for interacting with the memory management unit in such manner that it checks in the master record, depending on the identification information, as to what type of interaction the identified person wants with the attendance recording terminal. Furthermore, the control unit is configured in such manner that a user-specific type of interaction is provided for the identified person on the attendance recording terminal and/or on a mobile access medium of the person.

With regard to the computer-implemented method, a computer-implemented method for operating an attendance recording terminal, in particular time recording terminal, for recording attendance information of a person on the basis of an action of the person is proposed in detail, said method comprising at least the following steps:
identifying the person through an identification engine,
checking a master record of personal data as to what type of interaction the identified person wants with the attendance recording terminal, and
providing a user-specific type of interaction for the identified person.

The features and advantages described in the context of the proposed attendance recording terminal can be transferred accordingly to the proposed computer-implemented method for operating an attendance recording terminal. The computer-implemented method can be configured for operating that proposed and described attendance recording terminal. The proposed and described attendance recording terminal is in turn preferably configured for carrying out the proposed computer-implemented method for operating an attendance recording terminal. In this respect, the features and specific advantages relating to the attendance recording terminal or the method for operating the attendance recording terminal are generally only simply described together. Features described in connection with the device of the attendance recording terminal can be included in claims relating to the computer-implemented method accordingly.

An essential advantage of the present disclosure is that the attendance recording terminal (in short: terminal) advantageously provides a user-specific interaction option. It is first recognized which person specifically wants to interact with the terminal, or to which group of people the specifically interacting person is to be assigned, before the type of interaction is then provided in a user-specific manner. In this way, a large number of needs and preferences of the staff of employees can be specifically addressed. The interaction can then be adapted both in terms of language and with regard to individual specific needs. A barrier-free interaction behavior for the proposed attendance recording terminal is particularly advantageous because a simplified possibility of interaction can be made available by default, adapted to interacting people with a specific disability. In comparison to a uniform procedure with terminals from the state of the art, interaction with the terminals can thus be configured in a user-friendly manner for the entire heterogeneous staff of employees. It is particularly advantageous that the comparison and the resulting provision of the appropriate type of interaction take place automatically by communicating with the memory management unit in which the needs are stored in a master record. A time-consuming input by the interacting person as to what type of interaction they would like to carry out is therefore not necessary.

The control unit can be designed as an integral part of the attendance recording terminal or separately. For example, the control unit can also be displayed at a location other than within a housing of the attendance recording terminal or online, for example, and can communicate with the attendance recording terminal via a communication connection and control processes such as clocking processes.

The memory management unit can be provided locally and, for example, be an integrated part of the attendance recording terminal. Alternatively, the memory management unit can also be provided online in the cloud. The attendance recording terminal can then establish an online connection to the memory management unit, for example via the control unit, and in this way communicate with the memory management unit.

Master records of employee data can be stored in the memory management unit. Personal data stored there can, for example, include information about the working hours of the person, the language the person speaks so as to enable specific interaction with the attendance recording terminal, or individual preferences or requirements for the purpose of user-specific interaction. For example, it can be stored there if a person has a visual impairment or hearing impairment in order to enable interaction that is individually tailored to the needs.

The memory management unit can be configured for processing and storing the attendance information of the person.

The proposed terminal is generally positioned firmly on a wall or in the area of a corridor in an office building, a hospital or a factory building. For this purpose, the terminal can include a connection structure, for example, which connection structure serves to connect to a wall or to connect to a stand.

Furthermore, an electrical connection structure for connection to an existing electrical supply in the area is generally provided in the terminal. Although the terminal could also be configured to be battery-operated, it is preferred in the field of application in office buildings, factory buildings or hospitals to have the terminal permanently connected to a power source in the corresponding area.

As proposed, the attendance recording terminal has an identification engine. The identification engine can also be called an identification device. It provides a device to establish the identity of a person interacting with the attendance recording terminal. The identification engine can be implemented by software in the attendance recording terminal or as part of the control unit or can at least comprise software. Identification information is output via the identification engine. The identification information can clearly represent the interacting person or assign them to a group of people.

For this purpose, the identification engine can use the data in a way, which data result from the interaction of a nearby person with the terminal.

For example, a sensor unit can be provided for monitoring a surrounding zone, which sensor unit can output detected presence information of the person. The mentioned identification engine can, for example, use the detected presence information provided for identification purposes. For example, a photo taken by the sensor unit can be analyzed by the identification engine and assigned to a person. In the example of recording by the sensor unit, for example by means of wireless communication with a mobile access medium, such as an access card, a badge or a mobile device of the interacting person, that detected presence information, for example in the form of the identifier of the key card, can be further processed in the identification engine and used for identification purposes.

The person can then advantageously be identified on the basis of the detected presence information of the person.

Alternatively or additionally, the identification can also take place based on at least one item of other personal information. It is conceivable that the identification engine also has its own sensors, or that the sensor unit first provides detected presence information that basically only represents the attendance of a person, and then further personal information is obtained from the sensor unit, which serves to identify the person.

The other personal information does not have to include any personal data, but rather only enables the person to be identified unambiguously or to be able to clearly distinguish one person from other persons.

The control unit and the memory management unit are configured for interacting with one another. Using the recorded identification information, which is representative of the person interacting with the terminal, the control unit can check in the master record of the personal data as to which specific type of interaction the person prefers. For example, the person can prefer a voice-based interaction, for example via audio output on the terminal or on a mobile access medium of the person or, for example, visual interaction via displays on a display, be it on the terminal or on the mobile access medium. After checking in the master record, the control unit then provides the intended type of interaction desired by the person.

According to one embodiment of the attendance recording terminal, at least one sensor unit is provided, wherein the sensor unit is configured for monitoring a surrounding zone and, in particular, for outputting presence information of the person detected from the monitoring of the surrounding zone.

According to one embodiment of the computer-implemented method for operating an attendance recording terminal, it is proposed that, in order to identify the person, a surrounding zone is first monitored with at least one sensor unit.

The at least one sensor unit monitors the surrounding zone in the vicinity of the attendance recording terminal, such as a corridor of an office building at the attendance recording terminal or an entrance area of a building or a floor. This is where people are expected to interact with the attendance recording terminal. The sensor unit can include one or a plurality of sensors. Various sensor units or sensors can also be provided. The sensor unit or sensors can be integrated as an integral part of the attendance recording terminal, for example in its housing, or can be arranged entirely or partially outside of the attendance recording terminal, which is usually mounted on or in the vicinity of a wall. A communication connection can then advantageously be provided between the sensor unit and the attendance recording terminal, in particular its control unit.

Based on the monitoring, the sensor unit provides detected presence information of the person recorded in the surrounding zone. This may only be information that a person is present. Or there can also be a higher level of detail in the detected presence information, for example by a photo of the person being output as detected presence information.

By means of the monitoring via the sensor unit, the interacting person can be identified in the best possible way and thus an individual type of interaction adapted to the preferences can be provided. Interaction with the terminal is therefore more user-friendly for the heterogeneous group of interacting people.

According to one embodiment of the attendance recording terminal, a display is also provided on the attendance recording terminal and/or the attendance recording terminal is configured to be in communicative connection with a mobile access medium of the person comprising a display. The type of interaction includes at least the following aspect:
providing a user-specific user interface on the display of the attendance recording terminal and/or the mobile access medium of the person.

According to one embodiment of the computer-implemented method for operating an attendance recording terminal, it is proposed that the type of interaction includes at least the following aspect:
providing a user-specific user interface on the display of the attendance recording terminal and/or the mobile access medium of the person.

In this way, each person interacting with the terminal can be provided with a user interface for interaction that is individually adapted to their preferences, for example for clocking in, clocking out, registering a break, querying a credit balance, etc. User-friendly individualized interaction with the terminal is thus made possible for all users.

According to one embodiment of the attendance recording terminal, it is proposed that the user-specific user interface is provided in a user-specific font size and/or in a user-specific language.

According to one embodiment of the computer-implemented method for operating an attendance recording terminal, it is proposed that the user-specific user interface is provided in a user-specific font size and/or in a user-specific language.

In this way, the individual preferences of the employees can be better addressed. For example, individual visual impairments can be taken into account. Furthermore, different native languages of the interacting people can be taken into account. A user-friendly terminal is provided for the heterogeneous group of employees.

According to one embodiment of the attendance recording terminal, a or the display is provided on the attendance recording terminal and/or the attendance recording terminal is configured to be in communicative connection with a or the mobile access medium of the person comprising a or the display. The type of interaction includes at least the following aspect:
outputting a voice signal at the attendance recording terminal and/or on the mobile access medium of the person.

In particular, the voice signal is provided in a user-specific language and/or at a user-specific volume.

According to one embodiment of the computer-implemented method for operating an attendance recording terminal, it is proposed that the type of interaction includes at least the following aspect:
outputting a voice signal at the attendance recording terminal and/or on the mobile access medium of the person.

In particular, the voice signal is provided in a user-specific language and/or at a user-specific volume.

In this way, each person interacting with the terminal can have an interaction adapted to their preferences or needs, for example to clock in, clock out, register a break, query a credit balance, etc. In particular, consideration can be given to employees with reading difficulties or illiteracy. The different nationalities and languages of the employees can also be taken into account. User-friendly individualized interaction with the terminal is thus made possible for all users.

According to one embodiment of the attendance recording terminal, it is proposed that an intent engine (intent recognition device) is further configured for recording an intent of the interaction of the person with the attendance recording terminal, wherein the intent engine is configured in such manner that, in order to record the intent of the interaction of the person with the attendance recording terminal, a signal input by the person is used. In particular, the intent engine can also be configured in such manner that the signal input takes place as follows:
the intent engine receives a signal which is input by the person on a/the mobile device and which represents the intent of the interaction, and/or
the intent engine receives a voice input from the person representing the intent of the interaction or recognizes a gesture input from the person representing the intent of the interaction, and/or
the intent engine processes a signal which is input by the person at the attendance recording terminal, preferably at a touchscreen display, and which represents the intent of the interaction, and/or
the intent engine receives a signal which is triggered by the person by means of an action with a/the access card, a/the badge, and/or a/the mobile device and which represents the intent of the interaction.

The action of the person with their mobile access medium, such as the badge, can actually be a normal movement to initiate a clocking process (e.g. holding up the badge), wherein a predetermined sequence of movements, such as holding up the badge twice, repeatedly in quick succession, represents a specific intent.

According to one embodiment of the computer-implemented method for operating an attendance recording terminal, it is proposed that a desired interaction with the attendance recording terminal is selected and/or confirmed by the person in at least one of the following ways:
performing a predefined movement with a/the mobile access medium of the person, in particular once again placing the mobile access medium of the person, preferably in the form of a badge, on an interface of the attendance recording terminal; and/or
performing an input on the attendance recording terminal and/or on a/the mobile access medium of the person; and/or
performing a predefined gesture input; and/or
performing a predefined voice input.

The mobile access medium of the person can be designed as an access card, badge and/or mobile device. In this way, particularly simple contactless communication can take place between the person and the attendance recording terminal.

The intent engine can also be called an intent recognition device. It provides a device to determine the intent of the interaction of a person with the attendance recording terminal. Corresponding intent information can be output by the intent engine. The intent engine can be implemented by software in the attendance recording terminal or can comprise software.

Various data from the intent engine can be used as a basis to record the intent of the person. On the one hand, data stored in a master record of the person can be available as a variable for evaluation, for example when the shift or working time of the interacting person begins or it is generally a time at the beginning of the working day and the person appears at the attendance recording terminal, presumably to clock in for work. The movement data recorded by the sensor unit or other sensors can also be used as a basis. For example, it can be used to record whether a person is moving in the direction of the interior of the building or in the direction of the exit, or what the movement speed of the person is. In particular, the movement direction and/or the movement speed can therefore be used as evaluation data as the basis for the intent recognition.

It is also possible that more actions can be carried out at the attendance recording terminal than just clocking-in or clocking-out processes. For example, it may be possible for a person to want to query a credit stored on their key card or their badge, for example for use in a canteen. The intent engine can then, for example, also include the time of day in the analysis, which intent lies behind the interaction of the person with the attendance recording terminal, since the credit is regularly queried, in particular at lunchtime.

Predetermined types of movements, such as of the key card or badge, by the person interacting with the attendance recording terminal can also represent a predetermined intent, which the intent engine then recognizes and outputs corresponding intent information. There can also be intents to interact with the attendance recording terminal, which intents do not require a clear identification of the person. In the case of such intents, it may be sufficient to assign the detected person to a group of people who can or may in principle interact with the attendance recording terminal.

The intent engine can be configured in such manner that at least one of the following items of information is used to record the intent of the interaction of the person with the attendance recording terminal:
a movement direction of the person, and/or
a signal input by the person.

In the case of recording the intent based on the movement direction, the intent engine can also be configured in such manner that the movement direction is recorded via camera tracking and/or via an ultra-wideband signal. Other optical sensors and/or recording on the basis of a Time of Flight (ToF) can also be provided. Advantageously, the interaction between the person and the attendance recording terminal can take place contactlessly from a distance in this way, and it also does not require any individual input from the person, for example on the attendance recording terminal itself. In principle, movement directions or specific movements of the person themselves or their mobile access medium, for example, can represent specific intents of an interaction.

Basically, the provision of an intent engine allows an even more user-friendly interaction of the people with the terminal, since the intents of the interaction of the people can be automatically recorded and, if necessary, clocking processes can be carried out automatically.

According to one embodiment of the attendance recording terminal, it is proposed that a feedback engine (feedback device) is also provided, wherein the feedback engine is configured in such manner that when the person interacts or is requested to interact with the attendance recording terminal, a feedback signal is sent to the attendance recording terminal and/or can be output to a or the mobile access medium of the person. The feedback signal can be designed in particular in one of the following ways:
as an acoustic feedback signal; and/or
as a voice signal; and/or
as a haptic feedback signal, in particular a vibration signal, preferably on the mobile access medium of the person; and/or
as a graphic signal.

According to one embodiment of the computer-implemented method for operating an attendance recording terminal, it is proposed that the attendance recording terminal and/or a mobile or the mobile access medium of the person outputs a feedback signal about an interaction with the attendance recording terminal that has been carried out or requested. The feedback signal can be output in at least one of the following ways:
as an acoustic feedback signal; and/or
as a voice signal; and/or
as a haptic feedback signal, in particular a vibration signal, preferably on the mobile access medium of the person; and/or
as a graphic signal.

In particular, the feedback signal can also include a request or user information with which an operator of the attendance recording terminal (e.g. employer) requests the person who is interacting with the attendance recording terminal as a user to do something (e.g. request “report to the HR department”), “Please reduce overtime” etc.) or informs them about something (e.g. time account balance).

Provision can be made for sensitive personal information to be output only on a mobile device of the person, while general and non-sensitive information is output only on the terminal or on the terminal and the mobile device.

The feedback engine can also be referred to as a feedback device. The feedback engine can be implemented at least partially as software in the attendance recording terminal or in the control unit, via which software it can be checked, on the one hand, using the memory management unit whether the person wants feedback at all and, on the other hand, the corresponding feedback can be initiated. Accordingly, the feedback engine or the control unit can be in communication with a voice output unit if, for example, a voice signal is desired as the feedback signal.

According to a further embodiment, the memory management unit can be configured in such manner that, when an interaction has taken place, the memory management unit checks in the data of the person to determine whether feedback is desired about the interaction of the person with the attendance recording terminal. In this way, the interaction between people and the attendance recording terminal can advantageously take place in an individualized and in a particularly user-friendly manner, since it is specific to the respective person. It can particularly advantageous, for example, to check in the master record of the personal data before outputting a feedback signal as to whether the specific person who is performing the interaction and was previously identified wants feedback at all, and if so, in what form the feedback is wanted. Accordingly, the feedback engine can be configured in such manner that a person-dependent feedback signal can be output. For example, a voice signal can be given as feedback in the language that the interacting person speaks or understands. Furthermore, it can also be stored specifically for the person whether verbal feedback is desired at all or whether graphic or haptic feedback is desired. In addition, the individual needs of people can be addressed. In the event that a person has a hearing impairment, a voice signal can be dispensed with as a feedback signal, but only a graphic and/or haptic signal can be output. In the case of a person with a visual impairment, for example, an acoustic or voice signal or a haptic signal can preferably be used.

The user-friendliness of the terminal can thus be further improved since incorrect clocking processes can be avoided even better. In particular, a feedback signal can be sent, adapted to the individual preferences of an interacting person, about the clocking process or interaction that has taken place or has been requested, after which the interacting person can still make corrections. A requested interaction or the feature when the interaction of the person with the terminal is requested, in contrast to an interaction that has taken place, is to be understood as meaning that the desired interaction has been identified or recorded but has not yet been carried out. The feedback can first be given to the person and, for example, it can be possible to wait to check whether the requested interaction is not corrected again.

For this purpose, an interaction confirmation engine (interaction confirmation device) can preferably also be provided, wherein the interaction confirmation engine is configured for receiving clarifying intent information, wherein the clarifying intent information verifies or falsifies the intent of the interaction of the person with the attendance recording terminal. Then, depending on the feedback reported back to a person, this person can send positive, clarifying intent information to the attendance recording terminal to verify the intent, or negative clarifying intent information in order to prevent the planned action or clocking. The interaction confirmation engine can be implemented at least partially as software in the attendance recording terminal or in the control unit, via which software corresponding signals or actions of the person can be evaluated to confirm or deny the previously communicated intent of the interaction.

According to a further embodiment, the interaction confirmation engine can be designed as a voice detection engine (voice recognition device) for recording a voice input by the person and/or as a gesture detection engine (gesture recognition device) for recording a gesture input by the person. In this way, the intent of the interaction previously reported back by the attendance recording terminal to the person can be confirmed by the person via a simple voice input or via a predetermined gesture. The security of the clocking processes, to the extent that no incorrect clocking processes take place, can be further increased. The voice detection engine and/or the gesture detection engine can be implemented as software or comprise software.

Furthermore, the advantage is achieved by providing a computer program, which computer program includes commands which, when the program is executed by a processor of an attendance recording terminal, causes the attendance recording terminal to carry out the steps of the proposed method described above or below.

Furthermore, a computer-readable medium is proposed, on which the aforementioned computer program is stored.

### BRIEF DESCRIPTION OF THE DRAWINGS

Further advantageous and preferred configurations emerge from the following description with reference to the figures. In the drawings, which only show exemplary embodiments,

FIG. 1 shows a schematic configuration of an exemplary embodiment of the proposed attendance recording terminal;

FIG. 2 shows a flow chart of the method steps of a proposed computer-implemented method for operating an attendance recording terminal;

FIG. 3 shows a schematic configuration of an exemplary embodiment of an identification engine of the proposed attendance recording terminal;

FIG. 4 shows a schematic plan view of an arrangement of a proposed attendance recording terminal in a corridor; and

FIG. 5 shows a schematic configuration of an exemplary embodiment of a control unit of the proposed attendance recording terminal.

### DETAILED DESCRIPTION OF THE DRAWINGS

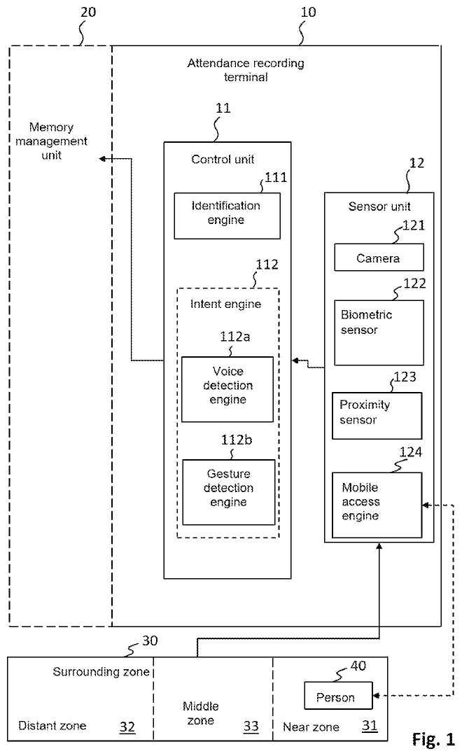

The configuration of an exemplary embodiment of a proposed attendance recording terminal 10 is shown schematically in FIG. 1. The attendance recording terminal 10 is a time recording terminal which serves the purpose of enabling time recording by employees, for example at the entrance to a company building. Specifically, different clocking processes can be carried out at the time recording terminal and thus different attendance information can be stored or processed. For example, an employee can clock his/her attendance in or out when he/she takes a break or when his/her working day is over.

The attendance recording terminal 10 is accordingly configured to record attendance information of a person 40 on the basis of an action of the person 40. As shown in FIG. 1, the attendance recording terminal 10 comprises at least one control unit 11 and also a memory management unit 20. The memory management unit 20 can be provided locally and, for example, be an integrated part of the attendance recording terminal 10, or the memory management unit 20 can also be provided online in the cloud. This is indicated in FIG. 1 by the dashed lines. The attendance recording terminal 10 can then establish an online connection to the memory management unit 20, for example via the control unit 11, and in this way communicate with the memory management unit 20.

Master records of the people 40, which people 40 interact with the attendance recording terminal 10, are stored in the memory management unit 20. Personal data, for example employee-specific information such as working hours, can be stored in the master records. The personal data is available to the attendance recording terminal 10 or its control unit 11 via a communication connection between the memory management unit 20 and the control unit 11. The memory management unit 20 also processes and stores the attendance information of the person 40 as intended, for example that they have now come to work and their working time recording should begin.

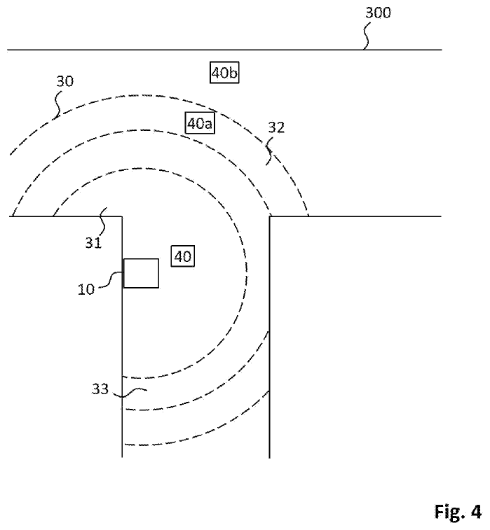

Furthermore, the attendance recording terminal 10 that is shown and is preferred in this respect has a sensor unit 12. The sensor unit 12 of the attendance recording terminal 10 monitors a surrounding zone 30, which surrounding zone 30 surrounds the attendance recording terminal 10 (cf. also FIG. 4). Accordingly, the sensor unit 12 receives signals from the surrounding zone 30, as indicated by the solid arrow pointing from the surrounding zone 30 to the sensor unit 12 in FIG. 1.

The sensor unit 12 can have different units for monitoring the surrounding zone 30. In the exemplary embodiment of FIG. 1, the sensor unit 12 has the following four units: a camera 121, a biometric sensor 122, a proximity sensor 123 and a mobile access engine 124. In this case, the sensor unit 12 can also have only one of the units or different combinations of the units. The provision of two units of the same type, such as for example two cameras 121, is also possible. A plurality of separately operating sensor units of different configurations can also be provided.

The presence of the person 40 in the surrounding zone 30 is first generally recorded via the mentioned units of the sensor unit 12. As a result of this, the sensor unit 12 can output detected presence information of the person 40. Specifically, for example, the camera 121 directed at the surrounding zone 30 monitors the corresponding room, for example a corridor surrounding the attendance recording terminal 10 (identified with reference numeral 300 in FIG. 4), and recognizes by means of image processing as soon as the person 40 enters the surrounding zone 30.

The biometric sensor 122 of the sensor unit 12 can in turn detect a direct action of the person 40 at the sensor unit 12 and thus at the attendance recording terminal 10. For this purpose, for example, the person 40 can perform a fingerprint scan on the biometric sensor 122 or trigger another signal.

The proximity sensor 123 of the sensor unit 12 can be designed in various embodiments and can detect the presence of the person 40 in the surrounding zone 30 in a contactless manner.

The mobile access engine 124 (mobile access device) of the sensor unit 12 records the presence of the person 40 in the surrounding zone 30 via a communication exchange between the mobile access engine 124 and the person 40, specifically a mobile access medium of the person 40. The mobile access medium of the person 40 can be an access card, such as a key card. A keyless transponder (badge) can also be used, or also a mobile device of the person 40, which mobile device has a specific application for communicating with the mobile access engine 124.

The mobile access engine 124 of the sensor unit 12 is configured in such manner that a communication exchange, indicated in FIG. 1 by the dashed double arrow, takes place between the mobile access engine 124 and the mobile access medium of the person in order to be able to record the presence of the person 40 and to output the detected presence information.

For example, the keyless transponder (badge) or the access card of the person 40 can also be equipped with RFID or also with UWB technology (ultra-wideband). A corresponding RFID or UWB module of the mobile access engine 124 then records when the person 40 enters the surrounding zone 30. This function can also be implemented via an application on the mobile device of the person 40.

The mobile access engine 124 can be implemented as software in the attendance recording terminal 10 or in the sensor unit 12 or comprise software via which software the communication exchange between the person 40 and the sensor unit 12 is evaluated and, if necessary, the detected presence information is generated and output.

If the sensor unit 12 observes, for example in one of the ways described, that a person 40 is in the surrounding zone 30 or is entering the surrounding zone 30, then the sensor unit 12 can output detected presence information of the person 40.

Furthermore, as shown in FIG. 1, the attendance recording terminal 10 has an identification engine 111 (identification device). This identification engine 111, for example integrated in the control unit 11, can identify the person 40 on the basis of that detected presence information of the person 40. In this case, the identification engine 111 is configured to output identification information, which identification information can be clearly representative of a respective person 40 or in any case can clearly assign that person 40 to a predefined group of people. For example, for some interactions it may not be absolutely necessary to uniquely identify the specific person 40, rather it may be sufficient to simply assign them to a group of people. For example, it can be recognized that the person 40 basically belongs to a “permitted” group of people, such that the person 40 can carry out an interaction as long as the interaction does not require a more in-depth, unambiguous identification.

The identification engine 111 can be implemented as software in the attendance recording terminal 10 or in the control unit 11 or can comprise software, via which software detected presence information of the person 40 or other personal information can be evaluated.

For example, if a person 40 was basically recognized by the sensor unit 12, then this person can be specifically identified by means of the identification engine 111. The aforementioned identification of the person 40 can be based, for example, on the detected presence information of the person 40 and/or on the basis of at least one other item of personal information. The one or the other item of personal information that can be used for identification purposes does not have to include any personal data, but only enables clarity regarding the person 40 or a person to be clearly distinguishable from other people.

In the example of a camera 121, the detected presence information can be a photo of the person 40. However, only the signal that the camera 121 has captured a person could also be made available to the control unit 11 or the identification engine 111 as simple detected presence information. The specific photo of the person 40 could be made available as other personal information, on the basis of which the specific identification then takes place.

The identification engine 111 is also configured to verify the person 40 and to output verification information. Verification here means a level of detail more than simple identification. The person 40 can be recognized per se or assigned to a group of people via the identification described. However, verification means more extensively that it is also checked whether the identified person 40 is a real person or whether there is a deception, since, for example, an attempt is being made at a deliberate incorrect clocking process. The person 40 is verified on the basis of the detected presence information of the person 40 and/or on the basis of the other personal information.

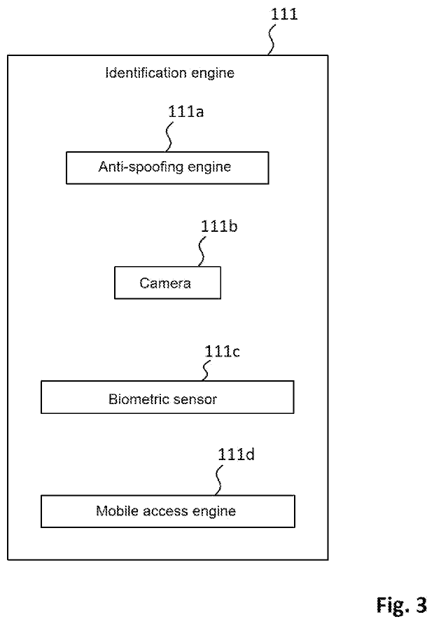

For this purpose, the identification engine 111 can include an anti-spoofing engine 111a, as can be seen in the exemplary embodiment in FIG. 3, which shows an identification engine 111 in detail. The anti-spoofing engine 111a, which can be implemented as software in the identification engine 111 or can comprise software, can be used to distinguish between real people and photos of a person that are merely held in front of the camera 121. Such an anti-spoofing engine 111a is particularly advantageous if cameras 121 are used as sensor units 12 in order to prevent a deliberately incorrect clocking process at the attendance recording terminal 10.

The identification engine 111 is therefore either provided with detected presence information or other personal information for evaluating and identifying the person 40, or the identification engine 111 can also detect corresponding information itself. For this purpose, as shown in the exemplary embodiment of the identification engine 111 in FIG. 3, the identification engine 111 can also comprise at least one of the following units: at least one camera 111b, at least one biometric sensor 111c, and/or at least one mobile access engine 111d. The functionalities of the individual units have already been described above in connection with the sensor unit 12, to which reference can be made. It should be explicitly mentioned that the mobile access engine 111d of the identification engine 111 is configured in such manner that, in order to identify the person 40, a communication exchange takes place between the mobile access engine 111d and a mobile access medium (badge, access card, mobile device or application on a mobile device or the like) of the person 40.

In principle, to reduce individual units, provision can also be made for the identification engine 111 to be able to access the units of the sensor unit 12 (camera 121, biometric sensor 122, mobile access engine 124) directly or to be provided with corresponding information from them.

Furthermore, provision can also be made for the sensor unit 12 and the control unit 11 or the identification engine 111 to be an integral part of the attendance recording terminal 10 and, for example, together with the corresponding sensors, to be installed together in a housing of the attendance recording terminal 10. However, it can also be advantageous to arrange the sensor unit 12 or a part of the sensor unit 12, for example the camera 121, outside of the attendance recording terminal 10 at a favorable point in the surrounding zone 30, while the identification engine 111, for example with its camera 111b, is an integral part of the attendance recording terminal 10. Then, using sensor unit 12, a person can advantageously initially be detected further away from attendance recording terminal 10, while the person 40 is identified by means of the identification engine 111 on the basis of the information generated at camera 111b on attendance recording terminal 10 itself.

For the purpose of a user-friendly interaction with the attendance recording terminal 10, the generally heterogeneous group of people 40 interacting with the terminal can be provided with different types of interaction. As proposed, it is advantageous for the control unit 11 to be configured for interacting with the memory management unit 20 in such manner that it is checked in the master record, depending on the identification information, which type of interaction the identified person 40 wants with the attendance recording terminal 10. In addition, the control unit 11 is configured in such manner that a user-specific type of interaction is provided for the identified person 40 on the attendance recording terminal 10 and/or on the mobile access medium of the person 40.

The corresponding proposed computer-implemented method for operating the attendance recording terminal 10 for recording attendance information of a person 40 on the basis of an action of the person 40 comprises the following steps:
identifying the person 40 through the identification engine 111,
checking a master record of personal data as to what type of interaction the identified person 40 wants with the attendance recording terminal 10, and
providing a user-specific type of interaction for the identified person 40.

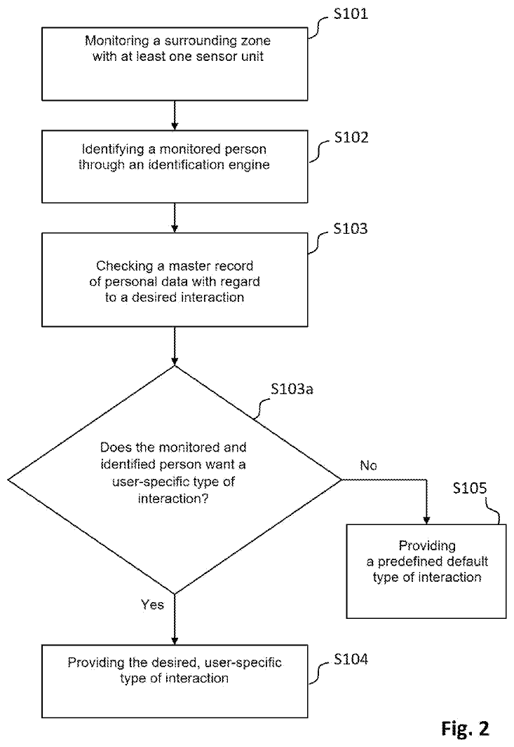

An exemplary embodiment of the proposed method is shown in FIG. 2, wherein, within the context of step S101, the surrounding zone 30 is first fundamentally monitored with the sensor unit 12. If a person 40 is detected, then this person is identified in step S102 using the identification engine 111. In the course of the subsequent step S103, a specific check is then carried out with regard to the identified person 40 in the master record of the personal data as to whether a specific type of interaction is desired (step S103a). If the result of this check is “yes”, then the desired user-specific type of interaction is provided for the person 40 as part of step S104. However, if the result of the check is “no”, then a predefined default type of interaction is provided (step S105).

One type of interaction includes, for example, providing a user-specific user interface on a display of the attendance recording terminal 10 and/or the mobile access medium of the person 40. For this purpose, the attendance recording terminal 10 can have a display and/or the attendance recording terminal 10 can be configured to be in communicative connection with the mobile access medium of the person 40 comprising a display.

The user-specific user interface is or will then be particularly advantageously provided in a user-specific font size and/or in a user-specific language for the type of interaction individually adapted to the preferences of the interacting person 40.

Additionally or alternatively, it is proposed that the type of interaction includes at least the aspect that a voice signal is output on the attendance recording terminal 10 and/or on the mobile access medium of the person 40. In this case, the voice signal is or will preferably be provided in a user-specific language and/or at a user-specific volume.

It is thus possible for a person 40 to have stored “voice control” as the preferred type of interaction. This could also be the case, for example, if the person 40 has visual or reading difficulties or is illiterate. Then, after this person 40 has been identified by the terminal, voice control is provided as a user-specific interaction type. The various clocking options such as “Clock in”, “Clock out”, “Check account balance”, etc. can be read out on the terminal itself or on the mobile access medium, for example on the mobile device of the person 40. This can preferably be done in the preferred language of the interacting person 40. The person 40 can then confirm or reject the action that has been read out and thus suggested, for example by means of their own voice signal (such as a “yes” or also a “no”). It is also possible to confirm an input by a specific movement, such as with a gesture or of the mobile access medium, such as the mobile device or badge.

In the case of another person 40, in turn, a “silent interaction”, for example by means of an application on the mobile device, could be preferred. No voice signals are then output, but rather the person 40 is shown interaction options on the mobile device, which the person 40 can select and thus perform the clocking process.

In principle, an intent engine 112 (intent recognition device) is configured and provided for recording an intent of the interaction of the person 40 with the attendance recording terminal 10. The intent engine 112 can be part of the control unit 11 and can be implemented as software in the attendance recording terminal 10 or in the control unit 11 or can comprise software, via which software specific information resulting from the actions of the person 40 can be evaluated.

The intent engine 112 recognizes the intent of the person 40, namely generally that or even specifically why that person 40 would like to interact or interacts with the attendance recording terminal 10. For this purpose, the intent engine 112 basically records the intent of an interaction of the person 40 and, for example, outputs intent information, which intent information represents the intent of the person 40 regarding the interaction. It can simply be the fact that the person 40 now wants to carry out an interaction, or it can also be the specific interaction itself, i.e. the specific intent of the interaction.

The specific intent of the interaction can be, for example, that the person 40 wants to clock in because their working time is beginning, or that they want to clock out of the time recording system. Furthermore, the specific intent of the person 40 can also be to call up specific information stored in the master record. For example, the person 40 could want to inquire about their attendance time or working time completed in a certain predefined period of time. It can also be possible to use the attendance recording terminal 10 to find out to what extent there is still credit on an access card or a person-specific employee card if the access card or the person-specific employee card (or a badge) is also suitable for payment in a canteen or the like. The memory management unit 20 preferably comprises the master record of corresponding personal data.

The intent engine 112 is preferably configured in such manner that, in order to record the intent of the interaction of the person 40 with the attendance recording terminal 10, a signal input by the person 40 is used. The signal input takes place as follows:
the intent engine 112 receives a signal which is input by the person 40 on the mobile access medium of the person 40, in particular on the mobile device, and which represents the intent of the interaction; and/or
the intent engine 112 receives a voice input from the person 40 representing the intent of the interaction or recognizes a gesture input from the person 40 representing the intent of the interaction, and/or
the intent engine 112 processes a signal which is input by the person 40 at the attendance recording terminal 10 and/or on the mobile access medium of the person 40, preferably on the display, and which represents the intent of the interaction, and/or
the intent engine 112 receives a signal which is triggered by the person 40 by means of a movement with the mobile access medium of the person 40 and which represents the intent of the interaction.

By means of the mentioned active inputs by the person 40, i.e. by performing:
a predefined movement with the mobile access medium, in particular once again placing the mobile access medium of the person 40 (preferably a badge) on an interface of the attendance recording terminal 10; and/or
an input on the attendance recording terminal 10 and/or on the mobile access medium of the person 40; and/or
a predefined gesture input; and/or
a predefined voice input

the person 40 can actively communicate their intent to the terminal. In this way, the risk of incorrect clocking processes can also be reduced.

Specifically, in the above-mentioned case of an active input of the person 40 on their mobile device, it is advantageous that the intent of the interaction can be unambiguously and clearly input by the person 40 without interpretation steps being required. For this purpose, the specific interactions with the attendance recording terminal 10 possible for the person can be displayed in an application on the mobile device of the person 40, particularly advantageously in the manner preferred by the person 40, and then selected by the person 40. The intent of the interaction is then recorded in the attendance recording terminal 10 by a corresponding communication of the mobile device with the attendance recording terminal 10 or specifically with the intent engine 112 and is provided, for example, as intent information and further processed.

In the previously alternatively or additionally mentioned case that the signal input takes place via the voice input of the person 40 or that the signal input takes place via a gesture input of the person 40, a corresponding voice detection engine 112a (voice recognition device) or gesture detection engine 112b (gesture recognition device) is provided. The voice detection engine 112a and the gesture detection engine 112b can be implemented as software in the control unit 11 or in the intent engine 112 or comprise software, via which the incoming voice signal of the person 40 or the detected gesture or movement the person 40 can be evaluated.

For example, the person 40 can communicate their intent to interact with the attendance recording terminal 10 via a voice input, such as calling out the word “clock in”. If that voice signal is recognized by the voice detection engine 112a, the intent engine 112 then knows that an interaction is desired and also specifically which one. In the case of a gesture, provision can be made, for example, for the person 40 to perform a specific movement, which is recorded by the sensor unit 12, for example, so that the gesture detection engine 112b then recognizes this as an intent to clock in or an intent to clock out and recognizes the corresponding intent information. A gesture can also be that the person 40 performs a predetermined movement with their mobile access medium, which movement is then received wirelessly at the attendance recording terminal 10 and recognized by the gesture detection engine 112b as corresponding intent information.

In the case also mentioned above, it is necessary, for example, for the person 40 to input a signal, for example on the touchscreen display of the attendance recording terminal 10 itself, in order to express their intent. In this case, only possible corresponding intents can also be predefined by the attendance recording terminal 10 on the display. The intent engine 112 then processes that input signal as corresponding intent information.

The surrounding zone 30 can be divided into a plurality of sub-zones, as can be seen in FIG. 1 and an example of an arrangement of an attendance recording terminal 10 in a corridor 300 also in FIG. 4. Thus, a near zone 31, which is arranged closest to the attendance recording terminal 10, and a distant zone 32, which is arranged furthest away from the attendance recording terminal 10, are provided. Between the near zone 31 and the distant zone 32 there is a middle zone 33.

Advantageously, the sensor unit 12 specifically recognizes in which sub-zone a person 40 is located and, if necessary, outputs a corresponding specific detected presence information of the person 40, specifically as a function of one or more zone-specific signal/signals, which originates/originate from the person 40 in the mentioned sub-zones.

In this case, the zone-specific signal does not have to be actively triggered by the person 40. Rather, the zone-specific signal is merely caused by the person 40, for example by the presence or by the type of advancing movement of the person 40 in the respective sub-zone. For example, a person 40 in the sub-zone or their movement can be tracked via camera tracking and a zone-specific signal can be generated from this. The zone-specific signal can thus be effected or caused by the simple presence or the movement of the person 40 in the sub-zone.

The following circumstances can flow into the zone-specific signal and thus into the specifically detected presence information of the person 40:
in which sub-zone the person 40 is located, and/or
which sub-zone the person 40 is entering, and/or
what does a movement pattern of the person 40 look like?

The movement pattern of the person 40 can relate to a movement direction of the person 40 and/or a movement speed of the person 40. The movement direction can be represented by a direction vector over time. The movement pattern of the person 40 within a surrounding zone or sub-zone can be recorded and used as a basis for the analysis of the intent of the interaction. Using the information regarding the sub-zone which a person 40 is entering, a change of zone by a person 40 can be detected and can be used as a basis for the analysis.

The technical means for detecting the position, i.e. the presence or the movement of the person 40 in a sub-zone, for example, can advantageously be the sensor unit 12. The sensor unit 12 advantageously includes a camera 121.

In this way, for example, individual engines or devices can be woken step by step or, in other words, the attendance recording terminal 10 can be put into different operating states depending on which sub-zone the person 40 is in or how the person 40 is moving for example in a sub-zone. For example, if the person 40 only enters the distant zone 32 and is basically detected there, but that person 40 does not approach the attendance recording terminal 10 any further and therefore does not enter the middle zone 33 or the near zone 31, it can be concluded that the person 40 does not want to interact with the attendance recording terminal 10 at all. Accordingly, the attendance recording terminal 10 can be operated in an energy-saving mode, for example, as long as the person 40 is not detected in the near zone 31 or at least not in the middle zone 33. Individual modules, which are basically necessary for the interaction of a person, can also be switched on step by step, as soon as the person 40 is detected in a predefined sub-zone.

The example shown in FIG. 4 of a corridor 300 having a T-junction illustrates the different sub-zones, represented by dashed partial circles, surrounding the attendance recording terminal 10 at different distances. The person 40 who is located in the near zone 31 interacts with the attendance recording terminal 10. The person 40a, in turn, is located in the distant zone 32, in which a basic detection of the person 40a takes place by means of the sensor unit 12 of the attendance recording terminal 10, but this detection would not result in the attendance recording terminal 10 having to operate. Only when the person 40a also enters the middle zone 33 or, depending on the desired configuration, the near zone 31, is a corresponding intent recognized via the interaction of the person 40, so that a change to a more active operating state takes place, for example. The third person 40b, in turn, is located outside the entire surrounding zone 30, so that in relation to the person 40b, said person is not detected at all. The attendance recording terminal 10 does not detect the person 40b in the configuration shown, since it is clear that no interaction with the attendance recording terminal 10 is desired by the person 40b.

At least one further control level or a plurality of control levels are also advantageously integrated into the attendance recording terminal 10. In this way, the person 40 can give feedback, i.e. feedback, about the clocking process carried out or just about the requested interaction, i.e. about the change made or planned change to the attendance information in the memory management unit 20 or also about the fact that no change was made.

The memory management unit 20 is then advantageously configured in such manner that when the attendance information has been stored, the memory management unit 20 checks in the data of the person 40 in its master record of the personal data whether feedback is desired about the interaction of the person 40 with the attendance recording terminal 10.

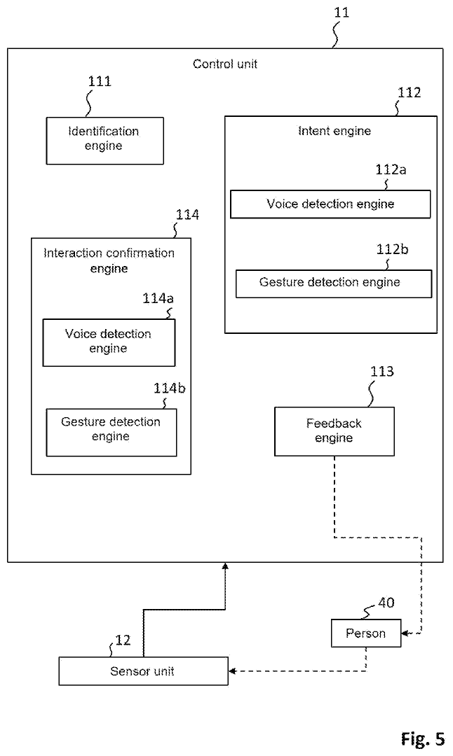

The attendance recording terminal 10 or the control unit 11 can also have a feedback engine 113 (feedback device) in addition to the identification engine 111 and intent engine 112, as shown in FIG. 5. The feedback engine 113 is configured in such manner that when the person 40 interacts or is requested to interact with the attendance recording terminal 10, a feedback signal can be output. The feedback signal can be output at the attendance recording terminal 10, for example on the display thereof or via loudspeakers, or also on the mobile access medium of the person 40. The feedback signal can be output as follows:
as an acoustic feedback signal; and/or
as a voice signal; and/or
as a haptic feedback signal, in particular a vibration signal, preferably on the mobile access medium of the person (40); and/or
as a graphic signal.

The feedback signal can, for example, also include a request or user information with which an operator of the attendance recording terminal (e.g. employer) requests the person 40 who is interacting with the attendance recording terminal 10 as a user to do something or informs them about something. A request to the person 40 could be as follows: “Report to the HR department”, “Please reduce overtime” etc. Simple information could be given about the current time account balance.

Provision can advantageously be made for sensitive, personal information to be output only on the mobile device of the person 40, while general and non-sensitive information is output only on the attendance recording terminal 10 or on the attendance recording terminal 10 and the mobile device.

The feedback engine 113 can be implemented at least partially as software in the attendance recording terminal 10 or in the control unit 11, via which software it can be checked, on the one hand, using the memory management unit 20 whether the person 40 wants feedback and, on the other hand, that corresponding feedback can be initiated. Accordingly, the feedback engine 113 or the control unit 11 can be in communicative connection with a voice output unit if, for example, a voice signal is desired as the feedback signal.

It is particularly advantageous to check in the master record of the personal data beforehand whether the specific person 40 who is performing the interaction and who was previously identified wants feedback at all, and if so, in what form the feedback is wanted. The feedback engine 113 can therefore be configured in such manner that a user-specific feedback signal can be output. For example, a voice signal can be output in the respective language of the person 40. Furthermore, for example, in the case of a person 40 with a hearing impairment, provision could be made for this person 40 to receive a different signal as a feedback signal, for example a graphic or haptic signal.

In order to increase the security of a correct interaction between the person 40 and the attendance recording terminal 10, an interaction confirmation engine 114 (interaction confirmation device) is also provided in the attendance recording terminal 10 or the control unit 11 in the exemplary embodiment of FIG. 5.

The interaction confirmation engine 114 may receive clarifying intent information. The clarifying intent information is intended to verify or falsify the already communicated and received intent of the interaction of the person 40 with the attendance recording terminal 10. In this case, it is then advantageous if the clarifying intent information represents further clocking information for the control unit 11. In addition to the identification information and intent information, it is then made dependent on this further clocking information whether or not the clocking process is to be carried out in the memory management unit 20.

For this purpose, the interaction confirmation engine 114 can be implemented at least partially as software in the attendance recording terminal 10 or in the control unit 11, via which software corresponding signals or actions of the person 40 can be evaluated to confirm or deny the previously recorded intent.

The interaction confirmation engine 114 can be designed as a voice detection engine 114a (voice recognition device) for recording a voice input by the person 40 and/or as a gesture detection engine 114b (gesture recognition device) for recording a gesture input by the person 40. For this purpose, reference can be made to the description of the voice detection engine 112a or gesture detection engine 112b above.

In concrete terms, clarifying intent information can include, for example, of the person 40 confirming via a voice signal (for example a pronounced “yes”) that they desire the recorded interaction and that this should be carried out. Contact-based clarifying intent information is also conceivable, for example in that the person 40 performs an input on the attendance recording terminal 10 or on their mobile access medium. However, voiceless and contactless confirmations by the person 40 are also conceivable, for example by the person 40 performing a specific gesture, for example also with their mobile access medium. A specific movement of the mobile access medium can be identified by the interaction confirmation engine 114 as clarifying intent information, for example via RFID or UWB technology.

The intent engine 112 is also advantageously configured for assigning distance information to the received intent information. This can be used to identify the distance from which the signal input or initiated by the person 40 comes. An example is that the intent information is communicated by the person 40 via a voice signal and, for example via the volume of the signal, the interaction detection engine 112 recognizes how far away the person 40 is. The clocking process can then be made dependent on the distance information corresponding to a predefined value range. A clocking process can therefore be prevented if the person 40 is still too far away from the attendance recording terminal 10. For the clocking process and the necessary comparison of the detected or received information with stored information, the interaction detection engine 112 can then be configured in such manner that the intent information is only further processed or output if the distance information corresponds to the predefined value range.

Furthermore, the person 40 can advantageously be given an indication by the attendance recording terminal 10 as to when the person 40 is close enough to the attendance recording terminal 10 and a clocking process is therefore possible. According to that exemplary embodiment, the control unit 11 is configured in such manner that if the detected presence information of the person 40 corresponds to a predefined value range, initiation information is output to the person 40 to notify that the interaction is possible.

The initiation information can be a voice signal or an acoustic signal and/or a graphic signal and/or a haptic signal, in particular a vibration signal. The initiation information can be output on the attendance recording terminal 10, for example via a loudspeaker or display of the attendance recording terminal 10, or also on a mobile access medium of the person 40, such as their mobile device.

The memory management unit 20 is preferably configured in such manner that when the initiation information is to be output to the person 40, the memory management unit 20 checks in the data of the person 40 as to what type of initiation information the person 40 desires. In this way, the individual needs or requirements of the person 40 can be addressed in a particularly advantageous manner. For example, a person 40 with a visual impairment could preferably have an acoustic signal or voice signal output as initiation information and not a graphic signal, while the situation is exactly the opposite for a person 40 with a hearing impairment. Signals containing speech or text can also be output as initiation information individually adapted to the person 40 in their respective language. The same applies to any feedback signals that can also be output in a person-specific manner, since person-specific information is stored in the master record of the data in the memory management unit 20.

The features and advantages described in the context of the proposed attendance recording terminal 10 can be transferred accordingly to the proposed computer-implemented method for operating an attendance recording terminal. Specifically, the computer-implemented method is configured for operating that proposed and described attendance recording terminal 10. The proposed attendance recording terminal 10 described here is in turn configured for carrying out the proposed computer-implemented method for operating an attendance recording terminal. In this respect, the features characterizing the attendance recording terminal 10 and the method for operating the attendance recording terminal 10 and specific advantages have been previously described and will be described below in general only simply.

1. An attendance recording terminal for recording attendance information of a person (40) on the basis of an action of the person (40), the attendance recording terminal comprising:
a control unit (11),
a memory management unit (20), wherein the memory management unit (20) comprises at least one master record of personal data, and
an identification engine (111), wherein the identification engine (111) is configured for identifying the person (40) and for outputting identification information,
wherein the control unit (11) is configured for interacting with the memory management unit (20) such that the control unit it-checks in the master record, depending on the identification information, as to what type of interaction the identified person (40) wants with the attendance recording terminal (10), and
wherein the control unit (11) is configured such that a user-specific type of interaction is provided for the identified person (40) on the attendance recording terminal (10),
wherein an intent engine (112) is further configured for recording an intent of the interaction of the person (40) with the attendance recording terminal (10), wherein the intent engine (112) is configured such that, in order to record the intent of the interaction of the person (40) with the attendance recording terminal (10), a signal input by the person (40) is used,
wherein the intent engine (112) is further configured such that the signal input takes place as follows:
the intent engine (112) receives a signal which is triggered by the person (40) by means of a movement of the mobile access medium of the person (40) and which represents and/or confirms the intent of the interaction.

2. The attendance recording terminal (10) according to claim 1, wherein at least one sensor unit (12) is provided, wherein the sensor unit (12) is configured for monitoring a surrounding zone (30) and for outputting presence information of the person (40) detected from the monitoring of the surrounding zone (30).

3. The attendance recording terminal (10) according to claim 1, wherein a display is also provided on the attendance recording terminal (10) and/or the attendance recording terminal (10) is configured to be in communicative connection with a mobile access medium of the person (40) comprising a display, and
wherein the type of interaction includes at least the following aspect:
providing a user-specific user interface on the display of the attendance recording terminal (10) and/or of the mobile access medium of the person (40).

4. The attendance recording terminal (10) according to claim 3, wherein the user-specific user interface is provided in a user-specific font size and/or in a user-specific language.

5. The attendance recording terminal (10) according to claim 1, wherein a/the display is provided on the attendance recording terminal (10) and/or the attendance recording terminal (10) is configured to be in communicative connection with a/the mobile access medium of the person (40) comprising a/the display, and
wherein the type of interaction includes at least the following aspect:
outputting a voice signal at the attendance recording terminal (10) and/or on the mobile access medium of the person (40),
wherein the voice signal is provided in a user-specific language and/or at a user-specific volume.

6. The attendance recording terminal (10) according to claim 1, wherein an intent engine (112) is also configured for recording an intent of the interaction of the person (40) with the attendance recording terminal (10), wherein the intent engine (112) is configured such that, in order to record the intent of the interaction of the person (40) with the attendance recording terminal (10), a signal input by the person (40) is used,
wherein, in particular, the intent engine (112) is further configured such that the signal input takes place as follows:
the intent engine (112) receives a signal which is input by the person (40) on a/the mobile access medium of the person (40), and which represents the intent of the interaction; and/or
the intent engine (112) receives a voice input from the person (40) representing the intent of the interaction or recognizes a gesture input from the person (40) representing the intent of the interaction, and/or
the intent engine (112) processes a signal which is input by the person (40) at the attendance recording terminal (10) and/or on a/the mobile access medium of the person (40), and which represents the intent of the interaction.

7. The attendance recording terminal (10) according to claim 1, wherein a feedback engine (113) is also provided, wherein the feedback engine (113) is configured such that when the interaction of the person (40) with the attendance recording terminal (10) takes place or is requested, a feedback signal is output at the attendance recording terminal (10) and/or on a/the mobile access medium of the person (40),
wherein the feedback signal is designed in at least one of the following ways:
as an acoustic feedback signal; and/or
as a voice signal; and/or
as a haptic feedback signal; and/or
as a graphic signal.

8. A computer-implemented method for operating an attendance recording terminal for recording attendance information of a person (40) on the basis of an action of the person (40), the method including the following steps:
identifying the person 40 through an identification engine 111,
checking a master record of personal data as to what type of interaction the identified person (40) wants with the attendance recording terminal (10), and
providing at least one user-specific type of interaction for the identified person (40), wherein the following is provided as a user-specific type of interaction with the attendance recording terminal (10): performing a predefined movement with a mobile access medium of the person (40), which represents and/or confirms the intent of the interaction, wherein the movement comprises placing the mobile access medium of the person (40) twice or once again on an interface of the attendance recording terminal (10).

9. The computer-implemented method according to claim 8, wherein, in order to identify the person (40), a surrounding zone (30) is first monitored with at least one sensor unit (12).

10. The computer-implemented method according to claim 8, wherein the type of interaction includes at least the following aspect:
providing a user-specific user interface on a display of the attendance recording terminal (10) and/or a mobile access medium of the person (40).

11. The computer-implemented method of claim 10, wherein the user-specific user interface is provided in a user-specific font size and/or in a user-specific language.

12. The computer-implemented method according to claim 8, wherein the type of interaction includes at least the following aspect:
outputting a voice signal at the attendance recording terminal (10) and/or on a/the mobile access medium of the person (40),
wherein the voice signal is provided in a user-specific language and/or at a user-specific volume.

13. The computer-implemented method according to claim 8, wherein a desired interaction with the attendance recording terminal (10) is selected and/or confirmed by the person (40) in at least one of the following ways:
performing a predefined movement with a/the mobile access medium of the person (40), once again placing the mobile access medium of the person (40), on an interface of the attendance recording terminal (10); and/or
performing an input on the attendance recording terminal (10) and/or on a/the mobile access medium of the person (40); and/or
performing a predefined gesture input; and/or
performing a predefined voice input.

14. The computer-implemented method according to claim 8, wherein the attendance recording terminal (10) and/or a/the mobile access medium of the person (40) outputs a feedback signal about an interaction with the attendance recording terminal (10) that has been carried out or requested, wherein the feedback signal is output in at least one of the following ways:
as an acoustic feedback signal; and/or
as a voice signal; and/or
as a haptic feedback signal; and/or
as a graphic signal.

15. A computer program comprising commands which, when the program is executed by a processor of an attendance recording terminal (10), causes the attendance recording terminal (10) to perform the steps of the method according to claim 8.
